(19) United States
(12) Patent Application Publication
(10) Pub. No.: US 2015/0298614 A1
(43) Pub. Date: Oct. 22, 2015

(54) SEATBACK WITH AN INTEGRATED STORAGE SLEEVE

(71) Applicant: GM Global Technology Operations LLC, Detroit, MI (US)

(72) Inventor: James F. Pywell, Shelby Township, MI (US)

(21) Appl. No.: 14/672,995

(22) Filed: Mar. 30, 2015

Related U.S. Application Data
(60) Provisional application No. 61/982,036, filed on Apr. 21, 2014.

(51) Int. Cl. B60R 7/04; B60N 2/64

(52) U.S. Cl. CPC B60R 7/043; B60N 2/64

(57) ABSTRACT

A number of variations may include a vehicle seatback having a storage sleeve.

### CROSS-REFERENCE TO RELATED APPLICATIONS

This application claims the benefit of U.S. Provisional Application No. 61/982,036 filed Apr. 21, 2014.

### TECHNICAL FIELD

The field to which the disclosure generally relates to includes vehicle seats, and vehicle seat and cabin combinations.

### BACKGROUND

Vehicles may include seats and a passenger cabin.

### SUMMARY OF SELECT ILLUSTRATIVE VARIATIONS

A number of variations may include a vehicle seatback having a storage sleeve.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a schematic illustration showing a seat including a seatback having an integrated storage sleeve according to a number of variations.

FIG. 2 is a perspective view of a seatback support showing a front face thereof according to a number of variations.

FIG. 3 is a perspective view of a seatback support showing a rear face thereof according to a number of variations.

FIG. 4 is a perspective view illustrating a seatback support showing the rear face thereof and including an integrated storage sleeve according to a number of variations.

FIG. 5 illustrates a storage sleeve useful in a number of variations.

FIG. 6 is a schematic illustration of a seatback support having a side bolster having an access window formed therein according to a number of variations.

FIG. 7 illustrates a seatback support having a side bolster having an access window formed therein according to a number of variations.

### DETAILED DESCRIPTION OF ILLUSTRATIVE VARIATIONS

The following description of the variations is merely illustrative in nature and is in no way intended to limit the scope of the invention, its application, or uses.

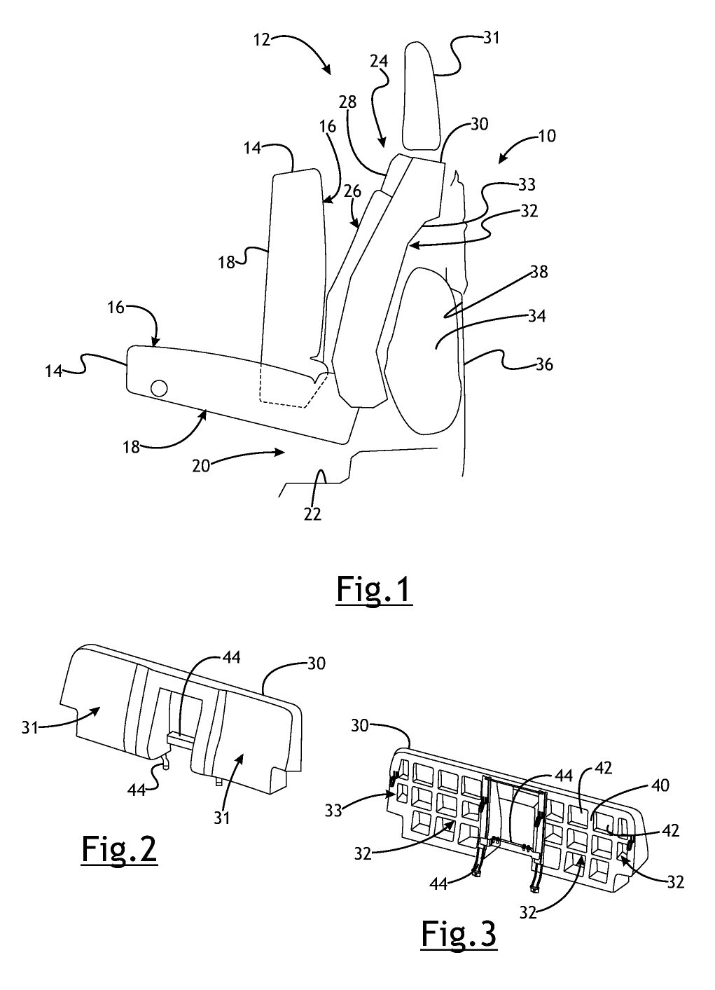

A number of variations are illustrated in FIG. 1 which may include a product 10 which may include a vehicle seat 12 which may have a seat bottom 14 having a top surface 16 constructed and arranged to support a human sitting thereon and an opposite bottom surface 18. The seat 12 may be placed in a vehicle cabin having a floor board 22 constructed and arranged to provide a storage space 20 between the bottom surface 18 of the seat bottom 14 when the seat bottom 14 is in a down position. In a number of variations the seat 12 may be constructed and arranged to be particularly suitable for use as a rear seat in a pickup truck cabin. The seat bottom 14 may be pivoted upward as shown in FIG. 1 so that the top surface 16 of the seat bottom 14 faces a seatback 24. The seatback 24 may include at least a first seatback cushion 26 provided over a seatback support 30. In a number of variations, a second seatback cushion 28 may also be provided over the seatback support 30 and may be located at a position above the first seatback cushion 26. In a number of variations, a headrest 31 may be provided and attached to the seatback 24. The vehicle may also include a cabin rear wall 36 which may have a notched portion 38 formed therein. The seatback support 30 may have a rear face 33 having a seatback support cargo or sleeve cavity 32 defined therein. The seatback support cargo or sleeve cavity 32 and/or the notch 38 formed in the vehicle cabin rear wall 36 may be constructed and arranged to receive a cargo bag or sleeve 34.

FIG. 2 is a perspective view illustrating a number of variations of the seatback support 30 showing a front face 31. In a number of variations the seatback support 30 may include a molded material which may be made a variety of polymers including, for example but not limited to, expanded polypropylene (EPP), or other polymeric materials which may also include reinforcing particles fibers or metal structures. In a number of variations, the seatback support 30 may be a molded material and may include a support frame 44 attached to or molded thereto.

FIG. 3 is a perspective view illustrating a seatback support 30 according to a number of variations showing a rear face 33 thereof. In a number of variations, the seatback support 30 may be constructed and arranged to provide a plurality of structural support beams 40 defining a plurality of cavities 42 in a manner sufficient to provide sufficient support for a human resting against the seatback support 30 and to reduce weight and cost of the seatback support 30. In a number of variations, one or more cargo or sleeve cavities 32 may be formed in the rear face 33 of the seatback support 30.

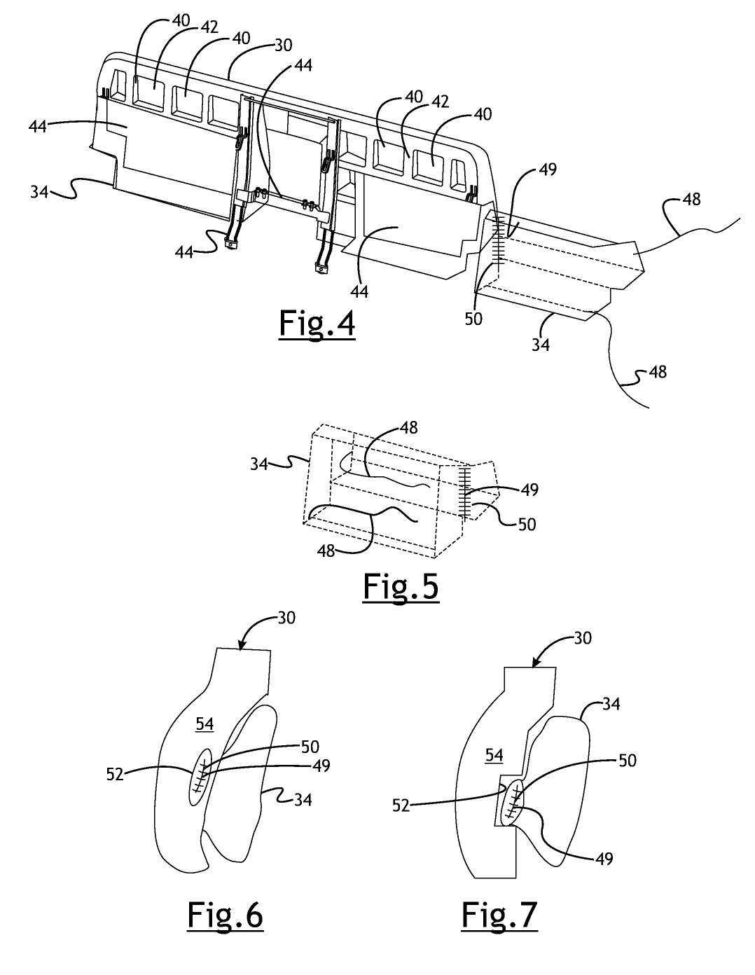

Referring now to FIG. 4, in a number of variations, an additional seatback material 44 may be provided to reinforce the seatback support 30 in the area defining the cargo or sleeve cavity 32 (shown best in FIG. 3). In a number of variations the additional seatback material 44 may include, but is not limited to, nylon. A cargo bag or sleeve 34 may be provided and connected to the seatback support 30. In FIG. 4, one of the cargo bags or sleeves 34 are shown in inside out position having been pulled out of the cargo or sleeve cavity 32 formed in the seatback support 30. To facilitate pulling the cargo or sleeve 34 out of the cargo or sleeve cavity 32, one or more tethers 48 may be attached to the cargo bag or sleeve 34 at one or more positions. The cargo bag or sleeve 34 may be constructed and arranged to close an opening 49 formed therein. In a number of variations, a closure 50 such as, but not limited to, a zipper, Velcro strips, snaps or the like may be provided on the cargo bag or sleeve 34 to close the opening 49 to conceal any contents placed inside of the cargo bag or sleeve 34.

FIG. 5 shows the cargo bag or sleeve 34 with an opening 49 closed by a zipper 50.

In a number of variations as illustrated in FIGS. 6-7, the seatback support 30 may include a side bolster 54 having an access window 52 defined therein and constructed and arranged to allow a person to insert a hand through the access window to gain access to the opening 49 of the cargo bag or sleeve 34 and to any contents therein. In a number of variations, the access window 52 may be a slit or slot (a variation of which is illustrated in FIG. 6) formed in the side bolster 54 of the seatback support 30. In a number of variations, the access window 52 may be formed by a notch (a variation of which is illustrated in FIG. 7) formed in the side bolster 54 of the seatback support 30.

In a number of variations wherein the cargo bag or sleeve 34 includes a closure 50, the contents of the cargo bag or sleeve 34 may be completely concealed.

Referring again to FIG. 3, although the seatback support 30 shown in FIG. 3 includes a center console opening, the seatback support may be constructed and arranged to provide a cargo bag or sleeve cavity 32 extending substantially from one end of the seatback support to another to receive a number of elongated objects including but not limited to a fishing pole or a rifle.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

The above description of select variations within the scope of the invention is merely illustrative in nature and, thus, variations or variants thereof are not to be regarded as a departure from the spirit and scope of the invention.

What is claimed is:

1. A product comprising a vehicle seat including a seatback support having at least one cargo bag or sleeve cavity defined in a rear face of the seatback support, and a cargo bag or sleeve secured to the seatback support.

2. A product as set forth in claim 1 wherein the cargo bag or sleeve includes an opening formed therein and further including a closure mechanism for closing the opening.

3. A product as set forth in claim 1 wherein the cargo bag or sleeve includes an opening and further comprising at least one tether secured to an inner face of the cargo bag or sleeve.

4. A product as set forth in claim 1 wherein the seatback support 30 includes a side bolster, and wherein the side bolster is constructed and arranged to provide an access window constructed and arranged to allow a person to gain access to the cargo bag or sleeve when the seat is placed in a vehicle cabin and wherein the vehicle includes a B&R line adjacent the seatback support.

5. A product as set forth in claim 4 wherein the access window comprises a slit or slot formed in a side bolster of the seatback support.

6. A product as set forth in claim 4 wherein the access window comprises a notch formed in a side bolster of the seatback support.

7. A product as set forth in claim 1 further comprising at least a first seat cushion over a front face of the seatback support.
